(19) United States
(12) Patent Application Publication
(10) Pub. No.: US 2025/0141324 A1
(43) Pub. Date: May 1, 2025

(54) METHOD FOR OBTAINING A ROTOR FOR A ROTARY ELECTRIC MACHINE

(71) Applicant: Valeo eAutomotive Germany GmbH, Erlangen (DE)

(72) Inventors: Abdelaziz KEBBACHE, Creteil Cedex (FR); Didier SELOSSE, Etaples-sur-Mer (FR); Jean-Philippe BADEY, Etaples-sur-Mer (FR); Paul ARMIROLI, Creteil Cedex (FR); Christophe MONTEIL, Creteil Cedex (FR); Jean-Clotaire ASSAMAGOA, Creteil Cedex (FR); Alexian BOUTINEAUD, Etaples-sur-Mer (FR)

(73) Assignee: Valeo eAutomotive Germany GmbH, Erlangen (DE)

(21) Appl. No.: 18/924,494

(22) Filed: Oct. 23, 2024

(30) Foreign Application Priority Data
Oct. 26, 2023 (FR) 2311697

(51) Int. Cl. H02K 15/03; H02K 1/2733; H02K 1/28; H02K 15/12

(52) U.S. Cl. CPC H02K 15/03; H02K 1/2733; H02K 1/28; H02K 15/12

(57) ABSTRACT

A method for obtaining a rotor of a rotary electric machine including a rotor body, a magnetic element and a ring. The method includes a step of positioning the rotor body inside an injection mould and a step of placing the ring inside the injection mould, such that the ring is placed around the rotor body. The magnetic element is injection moulded, in the form of a bonded magnet, between the rotor body and the ring.

The present invention relates to the field of motor vehicles, and more particularly to the electric machines with which these motor vehicles are equipped.

Electric or hybrid motor vehicles are equipped with rotary electric machines, in particular electric motors with at least a stator and a rotor. In some of these rotary machines, coils associated with the stator generate, when they are supplied with electrical power, a magnetic flux that allows rotation of the rotor equipped with magnets. In a radial flux rotary machine, the magnetic flux is generated in a radial direction relative to the axis of rotation of the electric machine and the rotor rotates around this axis of rotation as a function of the orientation of the radial magnetic field.

The rotors of these rotary machines conventionally comprise a ring and a magnetic element. This ring makes it possible to hold the magnetic element of the rotor in position, in particular ensuring it is held in place when the rotor is rotating at high speed. The ring comprises an inner radial wall, an outer radial wall and a bottom wall that delimit housings which are open at the top to receive portions of the magnetic element. The magnetic element is thus placed inside the ring, against a bottom of the ring.

The magnetic element is conventionally a solid magnet, meaning that assembly operations are required to secure it to the ring. However, both arranging the magnetic element inside the ring and securing them together are complex operations. To be specific, it is difficult to control the dimensional tolerances between these two components. Moreover, the manufacture of the rotor takes a long time and requires considerable investment, owing to the many positioning and assembly operations.

The present invention falls within this context and proposes a method for manufacturing a rotor by virtue of which production of the rotor is simplified while reducing the number of operations required.

The present invention thus has as main subject matter a method for obtaining a rotor of a rotary electric machine comprising a rotor body, a magnetic element and a ring, the obtention method comprising the following steps:
positioning the rotor body inside an injection mould;
placing the ring around the rotor body in such a way as to form an annular chamber;
injection moulding the magnetic element, in the form of a bonded magnet, in the annular chamber.

The obtention method according to the invention corresponds to the manufacture of a rotor intended to be integrated in a rotary electric machine and in particular in a radial flux rotary machine. The obtention method involves an injection mould having a cavity, inside which a rotor body and a ring are placed in turn, respectively during a step of positioning and a step of placement. Either the step of positioning of the rotor body takes place before the step of placement of the ring, or conversely, the step of placement of the ring occurs prior to the step of positioning of the rotor body. The rotor body is positioned right up close to a central peg of the injection mould while the ring is placed along an outer edge of this injection mould. The rotor body and the ring are arranged such that they are not in contact with one another; in other words, after the steps of positioning and placement there is a space between these two components. Since the rotor body and the ring have an annular shape, this space corresponds to an annular chamber.

Once the rotor body and the ring are arranged in the mould, the obtention method comprises a step of injection moulding during which a magnetic element of the rotor, in this case a bonded magnet, is injection moulded inside the injection mould in the annular chamber between the rotor body and the ring. The material constituting the bonded magnet then polymerizes so as to form, with the rotor body and the ring, an assembly of components that are rigidly secured to one another.

Using injection moulding makes it possible to easily manage the position of the bonded magnet relative to the positions of the rotor body and of the ring. To be specific, the bonded magnet matches both the shape of the rotor body and the shape of the ring. Injection moulding also makes it possible to dispense with the bottom wall of the ring, the bonded magnet being, during the obtention method, held in place by the injection mould. Moreover, injection moulding makes it possible to combine positioning and assembly operations, which were previously separate during the production of prior art rotors.

According to an optional feature of the invention, the rotor body comprises scores, a portion of the bonded magnet being inserted in the scores on the rotor body during the step of injection moulding.

The scores on the rotor body are cut-outs extending at least radially from an edge of the rotor body that faces the ring. The scores have an annular shape. They extend, according to the embodiments, over the entire periphery of the rotor body or over a portion of this periphery. When the bonded magnet is injection moulded in the injection mould, it fills these scores.

According to an optional feature of the invention, the ring comprises notches, a portion of the bonded magnet being inserted in the notches on the ring during the step of injection moulding.

The notches on the ring are cut-outs extending at least radially from a face of the ring that faces the rotor body. The notches are not continuous along this inner face of the ring; thus, there is a plurality of notches arranged at a distance from one another along the same circumference of the ring inscribed within the inner face of the ring facing the rotor body. When the bonded magnet is injection moulded in the injection mould, it fills these notches.

According to an optional feature of the invention, the obtention method comprises a step of pre-magnetization of the bonded magnet inside the injection mould, this pre-magnetization step involving coils arranged in the injection mould around an area where the ring is placed.

The coils are arranged equidistantly from one another inside the injection mould. Their orientation depends on the type of magnetization sought; thus, the coils will be straight, that is parallel to the axis of rotation of the rotor, for magnetization according to a Halbach array, or conversely they will be inclined relative to the axis of rotation of the rotor in the case of an inclined or twisted rotor. The pre-magnetization step has the purpose of orienting the magnetic charges of the bonded magnet made of a polymer material in which particles or grains of a magnetic material are embedded. These grains of magnetic material which contribute to forming the bonded magnet are thus oriented along field lines defined within the injection mould, which is inside a magnetic field. When the polymer constituting the bonded magnet polymerizes, the positions of its grains of magnetic material are fixed. The bonded magnet thus has a fixed magnetic orientation.

According to an optional feature of the invention, the obtention method comprises a step of magnetization of the bonded magnet outside of the injection mould.

The bonded magnet is re-magnetized in such a way as to return to it a magnetic charge respecting the orientations previously defined. To this end, the rotor body comprises indexing means making it possible to facilitate magnetization as a function of angular sectors defined during pre-magnetization.

The operations of pre-magnetization and magnetization may take place at different locations. For example, pre-magnetization may be performed at the supplier and magnetization at a client, the bonded magnet then undergoing a step of demagnetization between the step of pre-magnetization and the step of magnetization in order to facilitate transport thereof.

The invention also relates to a rotor of a rotary electric machine that can be produced according to the obtention method as described above, the rotor having an axis of rotation and comprising a rotor body and a ring arranged around the rotor body in such a way as to form an annular chamber, and a bonded magnet arranged in said annular chamber.

The rotor according to the invention is intended to form part of a rotary electric machine, for example a radial flux motor, with a view to its being fitted inside an electric or hybrid motor vehicle. The rotor body makes it possible to rigidly secure the bonded magnet to a drive shaft element of the rotary electric machine. The ring has the role of holding the bonded magnet in position when the rotor is rotating at high speed and of preventing the bonded magnet from shattering.

The rotor body, the bonded magnet and the ring are arranged in this order around the axis of rotation of the rotor, which is the result of the initial arrangement of the rotor body and of the ring inside the injection mould.

According to an optional feature of the invention, the bonded magnet comprises tabs which extend in a plane perpendicular to the axis of rotation of the rotor inside the rotor body and/or the ring.

In other words, the tabs of the bonded magnet extend radially inside the rotor body and/or the ring.

According to an optional feature of the invention, the tabs of the bonded magnet extend inside scores on the rotor body.

According to an optional feature of the invention, the tabs of the bonded magnet extend inside notches on the ring.

The presence of a portion of the bonded magnet, namely its tabs, inside the scores on the rotor body and/or the notches on the ring makes it possible to limit sliding between the various elements of the rotor during operation of the rotary electric machine.

According to an optional feature of the invention, the ring has an annular shape.

In particular, unlike prior art rings, the ring according to the invention has no bottom. Such a bottom, the function of which is to hold in place the bonded magnet, is in fact not necessary since the bonded magnet is injection moulded. Moreover, in the obtention method it is the injection mould that makes it possible to hold in place the bonded magnet.

According to an optional feature of the invention, the ring comprises at least one collar, preferably castellated, partially covering the bonded magnet.

The collar corresponds to an extra thickness of the ring which extends towards the axis of rotation of the rotor.

In some embodiments, the collar is discontinuous along a periphery of the ring, which enhances the feasibility of the method for obtaining the rotor. The purpose of this discontinuity is to block the rotation of the ring on the bonded magnet during the operation of the machine. Alternatively, the collar extends over the entire periphery of the ring.

According to an optional feature of the invention, the bonded magnet has an axial end edge which contributes to forming an axial peripheral edge of the rotor.

The axial end edge delimits the bonded magnet in a direction parallel to the axis of rotation of the rotor. The axial peripheral edge delimits the rotor in a direction parallel to this axis of rotation of the rotor. It will be appreciated that the bonded magnet is at least partially exposed in the rotor. In other words, the bonded magnet is not fully covered by the ring, this ring having no bottom wall.

According to an optional feature of the invention, the rotor body comprises a first portion intended to be in contact with a drive shaft element and a second portion in contact with the bonded magnet, the rotor body comprising branches extending radially between the first portion and the second portion.

The first portion and the second portion have annular shapes. They are connected to one another by the branches of the rotor body. When seen in cross section in a plane perpendicular to the axis of rotation of the rotor, the branches extend in a star formation from the first portion. The presence of branches connecting the first portion and the second portion instead of a solid body makes it possible to limit the weight of the rotor body.

According to an optional feature of the invention, the bonded magnet is made of a ferrite or rare earth alloy and a non-magnetic binder material.

The rare earth alloy comprises for example neodymium, iron and boron. The non-magnetic material is in particular a resin such as a thermoplastic based on polyamide or polyphenylene sulphide.

The invention also relates to a rotary electric machine comprising a rotor as described above and at least a stator.

Further features, details and advantages of the invention will become clearer on reading, on the one hand, the following description and on the other hand, examples of embodiments set out by way of non-limiting indication, with reference to the attached drawings, in which:

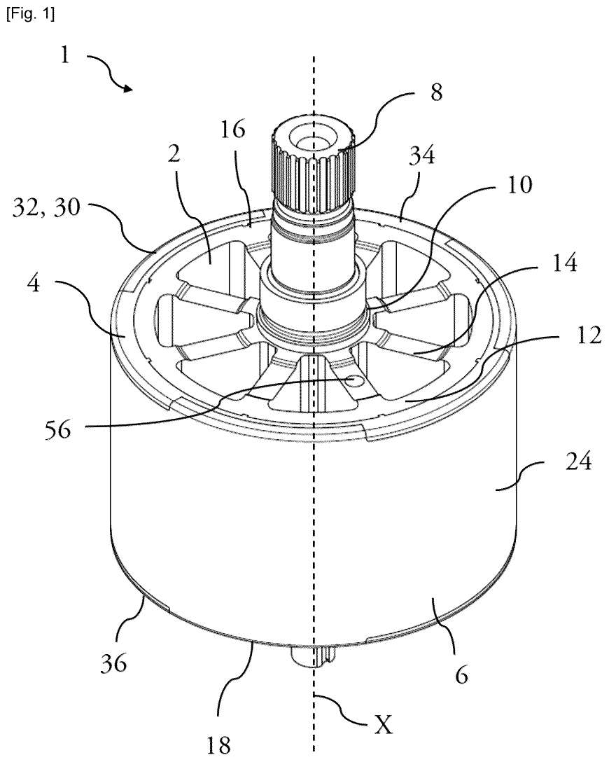

FIG. 1 depicts, schematically, a rotor of a rotary electric machine according to the invention, comprising a rotor body, a ring and a bonded magnet that has been injection moulded between the rotor body and the ring.

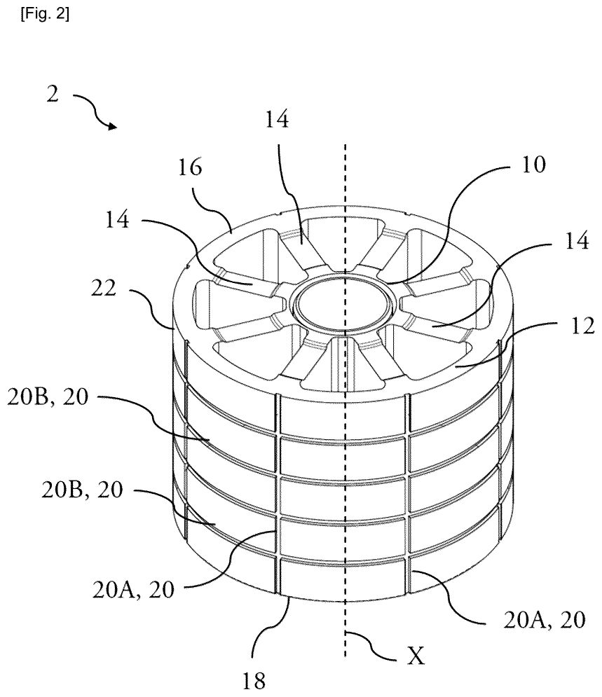

FIG. 2 depicts, schematically and on its own, the rotor body of FIG. 1.

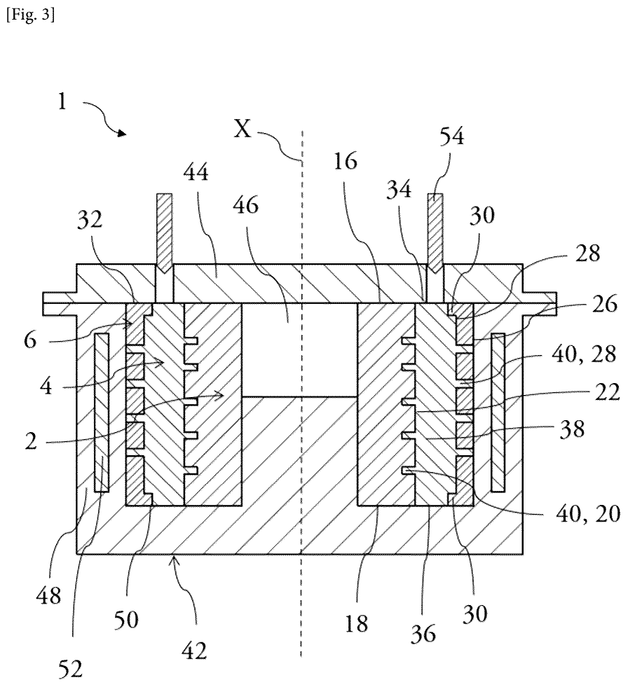

FIG. 3 depicts, schematically, an injection mould in which are arranged the rotor body, the ring and the injection-moulded bonded magnet of FIG. 1.

The features, variants and the various embodiments of the invention may be combined with one another, in various combinations, as long as they are not mutually incompatible or exclusive. It is possible in particular to envisage variants of the invention that comprise only a selection of features described below independently of the other features described, if this selection of features is sufficient to confer a technical advantage and/or to differentiate the invention from the prior art.

In the figures, elements that are common to multiple figures retain the same reference sign.

In the detailed description below, the terms “longitudinal”, “transverse” and “vertical” explain the orientation of the rotor for a rotary electric machine according to the invention, these terms referring to a reference system L, V, T shown in the figures. FIGS. 1 to 3 thus depict, schematically, a rotor 1 according to the invention. This rotor 1 is intended to be integrated in a rotary electric machine, for example a radial flux electric motor further comprising at least a stator, to be fitted in a hybrid or electric vehicle, for example a car, a truck, a bicycle or an object that moves using its own drive system such as a drone. Such a vehicle may further comprise an autonomous driving system.

The rotary electric machine is capable of operating in alternator mode in order to supply in particular power to the battery and to the onboard power system of the vehicle, and in motor mode, not only to start the combustion engine of the vehicle but also to contribute to providing traction to the vehicle, on its own or in combination with the combustion engine.

The power of the machine 10 may be between 4 KW and 50 KW. Alternatively, the electric machine 10 may be installed on an axle of the motor vehicle, in particular a rear axle. In the example under consideration, the electric machine advantageously has an operating voltage of less than 60 volts, and preferably of 48 volts Typically, the torque supplied by the electric machine is between 30 N·m and 150 N·m.

Alternatively, the electric machine may have an operating voltage of more than 60 V, indeed more than 80 V or more than 100 V, in particular 300 V or more. In the case of operation at high voltage, the machine will typically have an operating voltage of between 400 and 800 V, a power of up to 350 KW and will supply a torque of up to 400 N·m.

The rotor 1 comprises a rotor body 2, a magnetic element in the form of a bonded magnet 4 and a ring 6. These constituent elements of the rotor 1 are arranged in this order around an axis of rotation X of the rotor 1.

The rotor body 2 is arranged around a drive shaft element 8 which is shown in FIG. 1. The rotor body 2 is a metal element, for example made of steel. The rotor body 2 is composed of a first annular portion 10, a second annular portion 12 and branches 14 extending radially between the first portion 10 and the second portion 12. The first portion 10 surrounds the drive shaft element 8 while the second portion 12, having a larger diameter than the first portion 10, is arranged in contact with the bonded magnet 4. Between the first portion 10 and the second portion 12, the branches 14 extend in a star formation; it will be appreciated that between these branches, the rotor body 1 is devoid of material. The branches 14 are arranged at regular intervals between the first portion 10 and the second portion 12. In this case, the rotor body 2 comprises eight branches 14, but a rotor body 2 having a different number of branches 14 could be envisaged without departing from the scope of the invention.

The branches 14 extend over the entire height of the rotor 1, this height being measured along the axis of rotation X of the rotor 1. In other words, the branches 14 extend from a first axial peripheral edge 16 of the rotor body 2 to a second axial peripheral edge 18 thereof, these axial peripheral edges 16, 18 being opposite one another in a direction parallel to the axis of rotation X of the rotor 1.

The rotor body 2 has scores 20, visible in FIG. 2, which are formed in its second portion 12. The scores 20 are more specifically formed in a contact face 22 of the second portion 12 of the rotor body 2 which is intended to face the bonded magnet 4 and be in contact with the latter.

The scores 20, which are particularly visible in FIG. 2 in which the rotor body 2 is shown on its own, extend from the contact face 22 in the direction of the axis of rotation X of the rotor 1. The scores 20 do not pass right through the second portion 12. The scores 20 comprise first scores 20A which extend axially, that is parallel to the axis of rotation X of the rotor 1, and second scores 20B which extend radially around the second portion 12, that is along a circumference of the rotor body 2. It will be appreciated that the first scores 20A and the second scores 20B are perpendicular to one another. The grid of scores 20 which is thus formed in the rotor body 2 allows optimal coverage, but it is possible to envisage a different arrangement of the scores 20 without departing from the scope of the invention.

The rotor body 2 radially delimits the rotor 1 right up close to the axis of rotation X of the rotor 1, whereas the ring 6 radially delimits the rotor 1 for its portion furthest away from this axis of rotation X. In other words, the rotor body 2 constitutes an inner radial end of the rotor 1 in the vicinity of the axis of rotation X and the ring 6 constitutes an opposite outer radial end of the rotor 1 at a distance from the axis of rotation X.

The ring 6 is a non-magnetic annular element which is for example made of stainless steel or carbon. The ring 6 comprises an outer face 24 oriented towards the outside of the rotor 1 and an inner face 26, radially opposite the outer face 24, facing the bonded magnet 4 and the rotor body 2.

The ring 6 comprises notches 28 formed at least on its inner face 26. These notches 28 are in this case separated circumferentially from one another; in other words, they are not continuous along the ring 6. As can be seen in FIG. 3, the notches 28 are through-notches, in other words they extend from the inner face 26 of the ring to its outer face 24. In an alternative embodiment that has not been shown here, the notches 28 could extend radially over the entire circumference of the inner face 26, it being understood that they would then not be through-notches, in other words they would extend only partially through the thickness of the ring.

As can be seen in FIG. 3, which is a view in cross section showing both the scores 20 on the rotor body 2 and the notches 28 on the ring 6, the second scores 20B and the notches 28 are arranged at different heights in a direction parallel to the axis of rotation X of the rotor 1. In other words, a given second score 20B on the rotor body 2 is not arranged facing a given notch 28 on the ring 6.

As can be seen in FIGS. 1 and 3, the ring 6 has at least one collar 30. This collar 30 extends the annular body of the ring 6 in the direction of the axis of rotation X of the rotor 1. The collar 30 is arranged around a periphery 32 of the ring 6. This periphery 32 corresponds to a rim which delimits the ring 6 relative to a direction parallel to the axis of rotation X of the rotor 1. There is therefore a collar 30 for each of the peripheries 32 which delimit the ring 6, in other words on the first axial peripheral edge 16 of the rotor 1 and on its second axial peripheral edge 18.

As can be seen in particular in FIG. 1, the collar 30 is in this case castellated, that is it extends partially along the periphery 32. The collar 30 is in this case split into three portions distributed at regular intervals around the periphery 32. However, embodiments in which the collar 30 is continuous around the periphery 32 could be envisaged without departing from the scope of the invention.

The collar 30 partially covers the bonded magnet 4. The bonded magnet 4 has a generally annular shape. It extends radially between the contact face 22 of the second portion 12 of the rotor body 2 and the inner face 26 of the ring 6 and it extends, in a direction parallel to the axis of rotation X of the rotor 1, between a first axial end edge 34 and a second axial end edge 36. Between the first axial end edge 34 and the second axial end edge 36, the bonded magnet 4 comprises a central area 38. One of the collars 30 more particularly covers a portion of the first axial end edge 34 and the other of the collars 30 covers a portion of the second axial end edge 36. It will thus be appreciated that at the collar 30, the bonded magnet 4 has a height, measured in a direction parallel to the axis of rotation X of the rotor 1, less than a height of the bonded magnet 4 measured in the vicinity of the rotor body 2.

Moreover, owing to the collar 30, a radial dimension of the first axial end edge 34 of the bonded magnet 4 and/or a dimension of the second axial end edge 36, measured in a plane perpendicular to the axis of rotation X of the rotor 1 facing the collar 30, is less than a dimension of the central area 38 measured in this perpendicular plane.

As stated above, the collar 30 only partially covers the bonded magnet 4. Therefore, the bonded magnet 4 is exposed, at least partially, in the rotor 1. In other words, with the exception of the collar 30, the first axial end edge 34 of the bonded magnet 4 forms the first axial peripheral edge 14 of the rotor 1 and the second axial end edge 36 of the bonded magnet 4 forms the second axial peripheral edge 16 of the rotor 1.

As can be seen in particular in FIG. 3, the bonded magnet 4 has tabs 40. The tabs 40 correspond to an individual increase in a radial dimension of the bonded magnet 4 measured in a plane perpendicular to the axis of rotation X of the rotor 1. These tabs 40 extend radially from the central area 38 of the bonded magnet 4, in the direction both of the rotor body 2 and of the ring 6. The tabs 40 are more specifically positioned inside the scores 20 on the rotor body 2 and the notches 28 on the ring 6. Such positioning of the tabs 40 results from the injection moulding of the bonded magnet 4 in an annular chamber between the rotor body 2 and the ring 6 during an obtention method which will now be described in detail.

The method for obtaining the rotor 1 according to the invention leads to the manufacture of a rotor 1 as described above. The obtention method requires the use of an injection mould 42 of generally cylindrical shape with a round base. The injection mould 42 comprises an annular cavity which is delimited radially by a central peg 46 and by an annular rim 48. The cavity is delimited axially by a bottom wall 50 and by a cover 44. Coils 52 are arranged around the cavity, for example within the annular rim 48, as can be seen in FIG. 3.

The obtention method starts with steps of manufacture of the rotor body 2 and of the ring 6. The rotor body 2 is for example made of steel, while the ring 6 is made of stainless steel. The rotor body 2 and the ring 6 are each manufactured such that they have their respective scores 20 and notches 28.

The obtention method comprises a step of positioning the rotor body 2 inside the injection mould 42. The rotor body 2 is more specifically arranged against the bottom wall 50 and around the central peg 46 of the injection mould 42, a diameter of which is substantially identical to that of the drive shaft element 8 mentioned above. Thus, the first portion 10 of the rotor body 2 is in contact with the central peg 46.

During a placement step, the ring 6 is in turn arranged inside the cavity of the injection mould 42, in contact with its bottom wall 50 and with its annular rim 48. More specifically, the outer face 24 of the ring 6 is placed in contact with the annular rim 48. The method continues with a closure step in which the injection mould 42 is closed by the cover 44, which delimits a radial end of the rotor 1. The cover 44 rests on the rotor body 2 and on the ring 6. It will be understood from the above that the rotor body 2 and the ring 6 are arranged at a radial distance from one another inside the injection mould 42, in such a way as to form between them an annular chamber. According to the invention, during a step of injection moulding, the bonded magnet 4 is injection moulded inside this annular chamber between the rotor body 2 and the ring 6.

The material constituting the bonded magnet 4, in this case a rare earth alloy and a non-magnetic polymer, is thus injected into the injection mould 42 using injection nozzles 54. The material constituting the bonded magnet 4 is deposited against the bottom wall 50 of the cavity of the injection mould 42. It fills the annular chamber, along with the scores 20 on the rotor body 2 and the notches 28 on the ring 6. The material constituting the bonded magnet 4 is injected into the cavity of the injection mould 42 up to the first axial peripheral edge 16 of the rotor 1, and facing the collar 30, up to the periphery 32 of the ring 6.

Once the bonded magnet 4 has been injection moulded between the rotor body 2 and the ring 6, the obtention method comprises a pre-magnetization step during which the coils 52 arranged inside the annular rim 48 are supplied with electrical power in order to orient the magnetic charges of the bonded magnet 4. When the magnetic charges of the bonded magnet 4 are fixed, that is once the material constituting the bonded magnet 4 has polymerized, the rotor body 2, the bonded magnet 4 and the ring 6 form a one-piece assembly.

The rotor 1 thus formed may then be removed from the injection mould 42 and demagnetized for transport.

The obtention method then comprises a step of assembly of the rotor 1 to the drive shaft element 8, during which this drive shaft element 8 is inserted in the first portion 10 of the rotor body 2. The obtention method may continue with a magnetization step which makes it possible to return to the bonded magnet 4 a magnetic charge according to the orientations determined during the previous pre-magnetization step. The magnetization step is made easier by the presence of indexing means, in this case holes 56, which provide the operator manufacturing the rotor 1 with information concerning the orientation to be respected as defined during the pre-magnetization step. The rotor 1 may then be combined with a stator so as to form a rotary electric machine.

The present invention thus proposes a method for obtaining a rotor that is simplified in terms of the number of operations, management of the dimensional tolerances between a magnetic element and other components of the rotor being moreover facilitated.

The present invention is not limited to the means and configurations described and illustrated here, however, and also extends to all equivalent means and configurations and to any technically operational combination of such means.

1. Method for obtaining a rotor of a rotary electric machine comprising a rotor body, a magnetic element and a ring, the obtaining method comprising the following steps:
positioning the rotor body inside an injection mould;
placing the ring around the rotor body in such a way as to form an annular chamber;
injection moulding the magnetic element, in the form of a bonded magnet, in the annular chamber.

2. Method for obtaining a rotor according to claim 1, wherein the rotor body comprises scores, a portion of the bonded magnet being inserted in the scores on the rotor body during the step of injection moulding.

3. Method for obtaining a rotor according to claim 1, wherein the ring comprises notches, a portion of the bonded magnet being inserted in the notches on the ring during the step of injection moulding.

4. Method for obtaining a rotor according to claim 1, comprising a step of pre-magnetization of the bonded magnet inside the injection mould, this pre-magnetization step involving several coils arranged in the injection mould around an area where the ring is placed.

5. Method for obtaining a rotor according to claim 1, comprising a step of magnetization of the bonded magnet outside of the injection mould.

6. Rotor of a rotary electric machine that can be produced according to the obtaining method of claim 1, the rotor having an axis of rotation and comprising a rotor body and a ring arranged around the rotor body in such a way as to form an annular chamber, and a bonded magnet arranged in said annular chamber.

7. Rotor according to claim 6, wherein the bonded magnet comprises tabs which extend in a plane perpendicular to the axis of rotation of the rotor inside the rotor body and/or the ring.

8. Rotor according to claim 7, wherein the tabs of the bonded magnet extend inside scores on the rotor body.

9. Rotor according to claim 7, wherein the tabs of the bonded magnet extend inside notches on the ring.

10. Rotor according to claim 6, wherein the ring comprises at least one collar, preferably castellated, partially covering the bonded magnet.

11. Rotor according to claim 6, wherein the bonded magnet has an axial end edge which contributes to forming an axial peripheral edge of the rotor.

12. Rotor according to claim 6, wherein the bonded magnet is made of a ferrite or rare earth alloy and a non-magnetic binder material.

13. Rotary electric machine comprising a rotor according to claim 6 and at least a stator.

14. Method for obtaining a rotor according to claim 2, wherein the ring comprises notches, a portion of the bonded magnet being inserted in the notches on the ring during the step of injection moulding.

15. Method for obtaining a rotor according to claim 2, comprising a step of pre-magnetization of the bonded magnet inside the injection mould, this pre-magnetization step involving several coils arranged in the injection mould around an area where the ring is placed.

16. Method for obtaining a rotor according to claim 2, comprising a step of magnetization of the bonded magnet outside of the injection mould.

17. Rotor of a rotary electric machine that can be produced according to the obtaining method of claim 2, the rotor having an axis of rotation and comprising a rotor body and a ring arranged around the rotor body in such a way as to form an annular chamber, and a bonded magnet arranged in said annular chamber.

18. Rotor according to claim 8, wherein the tabs of the bonded magnet extend inside notches on the ring.

19. Rotor according to claim 7, wherein the ring comprises at least one collar, preferably castellated, partially covering the bonded magnet.

20. Rotor according to claim 7, wherein the bonded magnet has an axial end edge which contributes to forming an axial peripheral edge of the rotor.
